(19) United States
(12) Patent Application Publication
(10) Pub. No.: US 2008/0278960 A1
(43) Pub. Date: Nov. 13, 2008

(54) ILLUMINATING STRUCTURE

(75) Inventors: Drew Smith, Eagan, MN (US); Susan Haug, Henderson, MN (US)

Correspondence Address: Altera Law Group, 1700 U.S. Bank Plaza South, 220 South Sixth Street, Minneapolis, MN, 55402, US

(73) Assignee: Seasonal Specialties

(21) Appl. No.: 12/175,172

(22) Filed: Jul. 17, 2008

Related U.S. Application Data
(63) Continuation of application No. 11/440,375, filed on May 24, 2006.

(51) Int. Cl. F21V 17/06

(52) U.S. Cl. 362/433

(57) ABSTRACT

The present invention relates generally to illuminated ornamental and/or decorative sculptures and/or structures. More particularly, the present invention relates to an illuminated structure having a plurality of individual optical elements disposed thereon.

### FIELD OF THE INVENTION

The present invention relates generally to illuminated ornamental and/or decorative sculptures and/or structures. More particularly, the present invention relates to an illuminated structure having a plurality of individual optical elements disposed thereon.

### BACKGROUND

Illuminated sculptures in the shape of holiday themed figures have existed for many years. Most of the conventional sculptures are configured out of a wire frame that serves as an outline for a figure or object. Lights are wrapped around or affixed on the frame to illuminate the sculpture. At night, when the framed outline is illuminated the features of the particular figure are easily seen. However, during the day, when the sculpture is not illuminated the figure is not as easily seen, nor as pleasing to the eye.

There are improved illuminated sculptures, such as is disclosed in U.S. Pat. No. 5,955,156 to Hermanson, that attempt to overcome the problem of the illuminated structures in daylight. The illuminated sculpture disclosed in the '156 patent includes translucent panels that are placed in closed portions of the outlined frame. These panels give shape and form to the outlined frame in the daylight. However, even with the panels, the sculpture of the '156 patent is generally planar and does not reflect any light during the day.

Another illuminated sculpture is disclosed in U.S. Pat. No. 6,905,229 to Fan, wherein a transparent thermoplastic layer is applied to the frame. The thermoplastic layer is applied in liquid form and acts as a “skin” on the frame. Thus, the thermoplastic layer gives some shape and dimension to the sculpture in daylight. The thermoplastic layer is applied in varying thickness and as such the light string shines through the thermoplastic layer and is reflected and refracted through the irregularities in the thermoplastic layer. The thermoplastic coating does not provide any reflection or refraction of natural or ambient light.

The present invention overcomes the aforementioned disadvantages by providing an improved illuminated structure which has depth and dimension when lit at night and during daylight as well as the added benefit of individual optical elements that reflect and refract light from the illuminated structure as well as natural or other light from outside the illuminated structure.

### SUMMARY OF INVENTION

The primary objective of the present invention is to provide an improved illuminated sculpture which is surrounded by optical elements allowing for light reflection and refraction in daylight and darkness which gives a very pleasing visual effect, and enhances the three-dimensional depth of the structure. Such visual effects include shimmering, glittering, twinkling and/or sparkling, and may include holographic effects as well.

It is another objective of the present invention to provide an improved illuminated sculpture wherein the optical elements may be in varying colors to emphasize particular features of the illuminated structure.

It is yet another objective of the present invention to provide an improved illuminated sculpture wherein the optical elements provide a prismatic effect that is visually pleasing.

It is another objective of the present invention to provide a structure carrying optical elements with surfaces that are mirrored, transparent, prismatic, metallic, faceted, holographic or any combination thereof.

### BRIEF DESCRIPTION OF THE DRAWINGS

FIG. 1 is a perspective view of an embodiment of the present invention.

FIG. 2 is a perspective view of another embodiment of the present invention.

FIG. 3 is a perspective view of various optical elements.

FIG. 4 is a perspective view of individual optical elements strung together.

FIG. 5 is a perspective view of an externally illuminated structure of the present invention.

### DETAILED DESCRIPTION

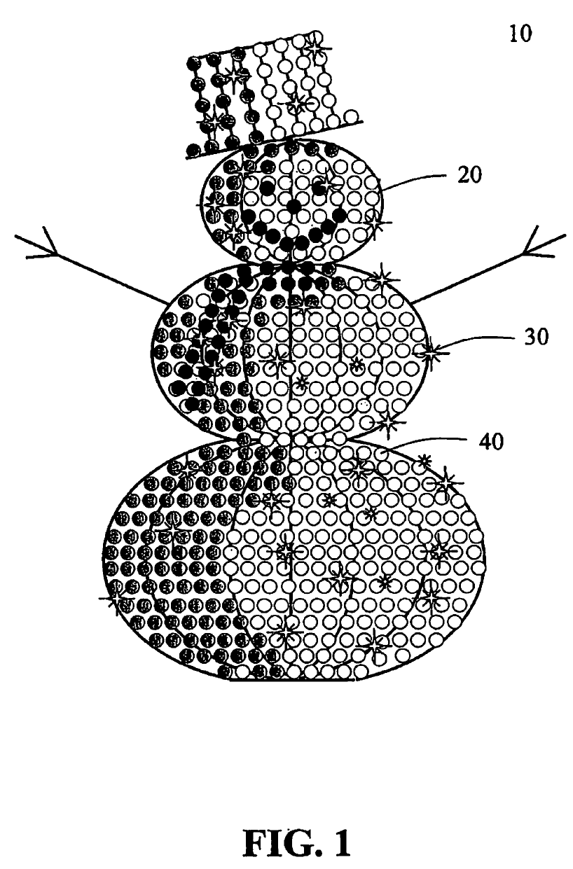

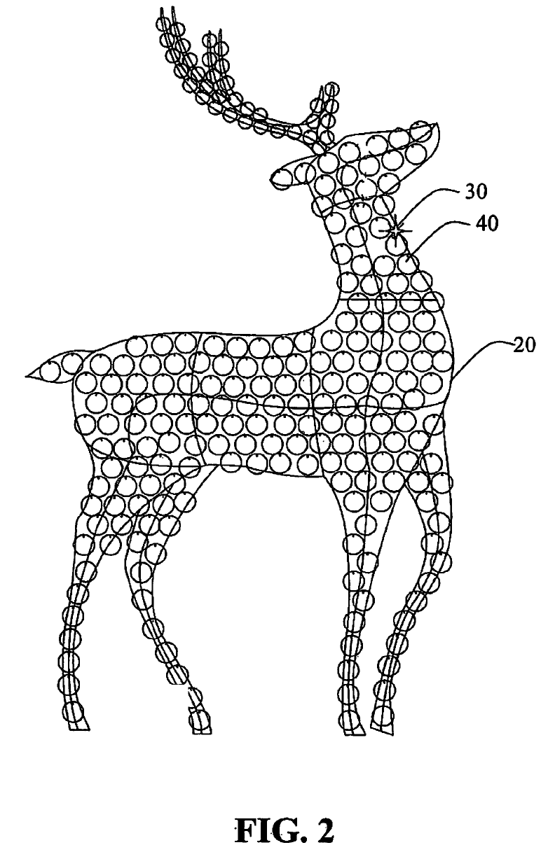

Referring to FIG. 1, the illuminated sculpture and/or structure 10 includes a frame 20 having a light source 30 and at least a portion of the illuminated sculpture 10 having a plurality of individual optical elements 40 disposed thereon. The frame 20 may be comprised of metal, wire or other suitably rigid material. The frame 20 may be coated for weather proofing and corrosion resistance. The frame 20 may be configured in any desired shape or form. Such desired shapes and forms may include seasonal figures such as snowmen, reindeer, and Santa Claus or any other seasonal or non-seasonal shape or figure. The illuminated structure and/or sculpture 10 may be used indoors or outside. The frame 20 may form a three dimensional structure. In another embodiment, the frame 20 may form a structure wherein only a portion of the structure is three dimensional, for example, the illuminated structure 10 may comprise a flat back portion and a slightly raised front portion.

The structure and/or sculpture may be illuminated by artificial light or by natural light, or both. The light source 30 may be of any know form including light emitting diodes, solar lights, incandescent lights, or any other light emitting object. Illumination of the structure may also be achieved by sole or partial contributions from natural light, including direct and/or non-direct sun or moon light. The light source 30 may be a plurality of lights or in an alternate embodiment a single light source. Further, the light source 30 may be clear or any variety of desired colors to increase the visual impact of the illuminated structure 10.

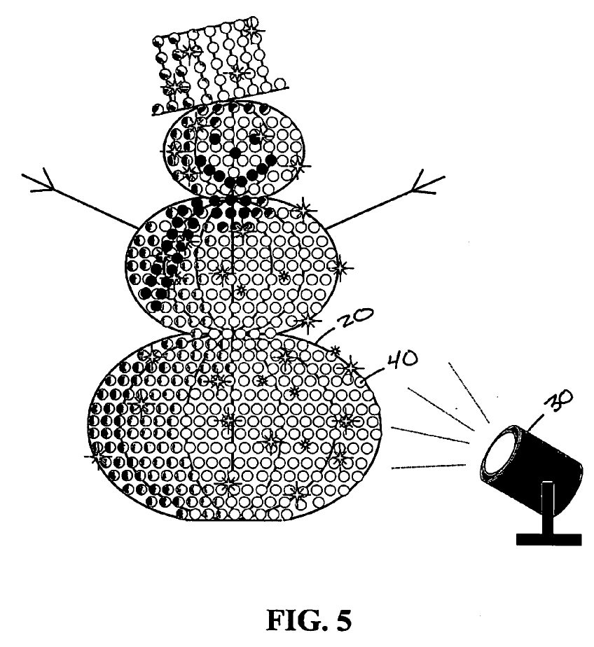

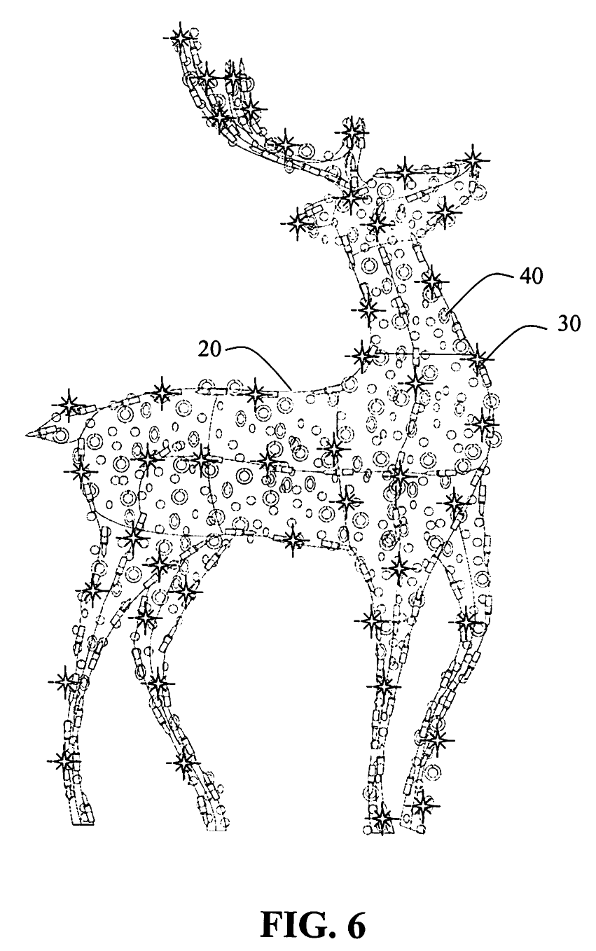

The light source 30 may be disposed on the frame 20, positioned external to the frame, or positioned internal to the frame. FIG. 5 depicts an embodiment of the present invention wherein the light source 30 is positioned external to the frame 20. The light source 30 may be attached, affixed, wrapped or otherwise secured to or disposed on the frame 20. The light source 30 may be a plurality of lights individually secured to the frame 20 or a plurality of lights may be strung or otherwise held together and collectively secured to the frame 20. The light source 30 may be secured to the frame 20 at one point on the frame 20 or at several points on the frame 20. In an embodiment, the light source 30 may be a plurality of individual lights secured to the individual optical elements 40 and together the lights and the individual optical elements may be disposed on the frame 20. One of ordinary skill in the art will recognize that additional methods of securing or disposing the artificial light source 30 on, in or around the frame 20 are contemplated and are within the scope of the present disclosure.

In an embodiment of the present invention, the illuminated structure 10 may comprise a generally flat and/or two dimensional structure. In a generally two dimensional embodiment, the light source 30 may be integral to the structure 10, in that the location of the light source 30 is not user controlled. Examples of the light source 30 being provided integrally with the structure 10 include, for example, the light source 30 being mounted on the frame 20, the light source 30 being raised off the frame, while still having a portion of the light source attached to the frame 20, and/or an external light source that is connected at a fixed distance from the frame. One of ordinary skill in the art will recognize that additional methods of integrally providing the light source 30 with the illuminated structure 10 are contemplated and are within the scope of the present disclosure.

The illuminated structure 10 according to the present invention further includes a plurality of individual optical elements 40 disposed on at least a portion of the frame 20. The individual optical elements 20 at least partially reflect and/or partially refract light, both from the light source 30 and any other outside and/or natural light source, such as for example, sunlight. The individual optical elements 40 may be strung together, for example, as shown in FIG. 4. The individual optical elements 40 may be strung together for example on a single string 50a or on two strings 50a and 50b. The string of optical elements 40 may be secured around the frame 20 to achieve the desired vision effects and depth enhancement. In an embodiment, a string of individual optical elements 40 may be secured to the frame 20 at one place and then wrapped around the frame 20 to achieve the desired form. In another embodiment, a string of individual optical elements 40 may be secured at several places on the frame 20 and wrapped and/or draped on the frame 20 to achieve the desired form.

In yet another embodiment, the individual optical elements 40 may be secured to a net-like form. The net may then be draped over the frame 20 and secured to the frame 20 to achieve the desired depth and dimension. In another embodiment, the individual optical elements may be secured or otherwise disposed on the frame 20 one by one. The individual optical elements 40 need not be strung together and may be placed on the frame 20 in any manner that achieves the desired depth and dimension to enhance the particular configuration of the illuminated structure 10. In a preferred embodiment, the individual optical elements 40 are disposed on at least a portion of the frame 20 to achieve three dimensional depth and form. One of ordinary skill in the art will recognize that additional methods of securing or disposing the individual optical elements 40 on the frame 20 are contemplated and are within the scope of the present disclosure.

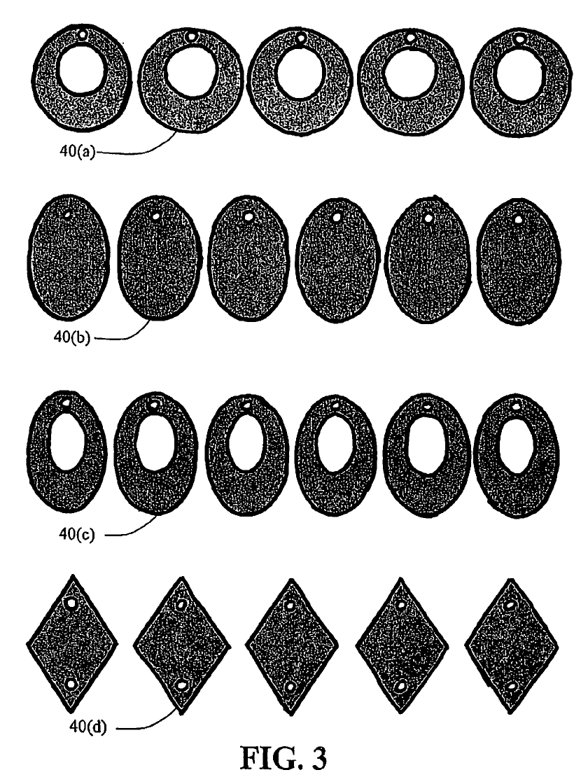

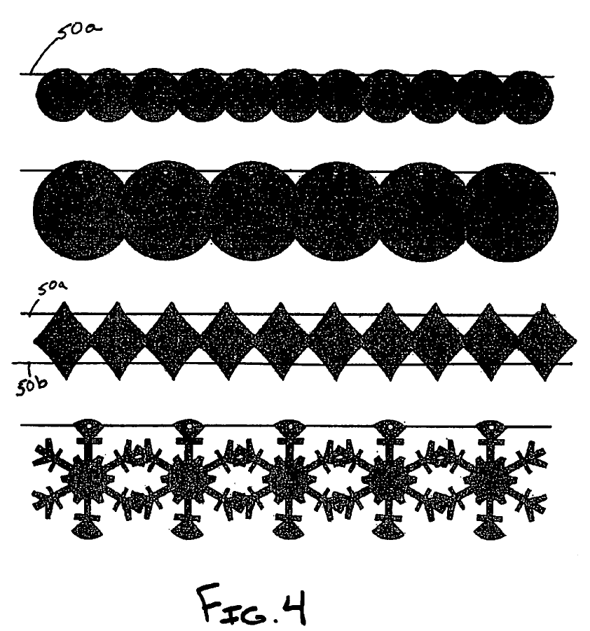

The optical elements 40 may be in the form of discs, beads, prisms, sequins or any other form that at least partially reflects and/or refracts light. The optical elements 40 maybe individually suspended from one point, to allow more movement, or from more than one point, for less movement and more security. FIG. 3 depicts various examples of optical elements 40(a)-40(d) that may be used according to the present invention. The optical elements 40 are disposed on and/or around the frame 20 such that the light emitted from the lights 30 reflects and/or refracts off the optical elements 40. The optical elements 40 may be made of thermoplastics such as polyvinyl chloride or acrylic, glass, mirrors, or any other suitable at least semi-reflective and/or refractive material. In a preferred embodiment the optical elements 40 are weather resistant for outdoor use.

The optical elements 40 may be transparent, semi-transparent white, semi-transparent colored, colored, or holographically colored. The optical elements 40 may be mirrored, transparent, prismatic, metallic, faceted, holographic or any combination thereof. The improved illuminated structure 10 may include a combination of optical elements 40. For example, some optical elements 40 may be one color and or shape and other optical elements 40 may be a different color or shape or mirrored optical elements 40 may be mixed with faceted optical elements and so forth.

In a preferred embodiment, the optical elements 40 visually enhance the illuminated structure and/or sculpture 10 at night by providing at least portions of the illuminated structure and/or sculpture 10 with the desired visual effects and enhanced three-dimensional appearance through the illumination of the optical elements 40. The optical elements 40 may provide a shimmering, glittering and/or sparkling effect, such as for example, when the wind moves the optical elements or when the optical elements 40 otherwise reflect or refract the illuminating light. Also, when one moves around the illuminated sculpture 10 and views the sculpture from different lines of sight, one will see light being reflected and/or refracted off of different optical elements 40 that come into the angle of reflection as your line of sight changes creating the described visual effect and enhancements.

The optical elements 40 also provide the illuminated structure with added visual interest. For example, in FIG. 1, the snowman's body, hat and scarf may all be of different colors and textures through the use of a combination of optical elements 40. In addition, because the optical elements may be placed individually or collectively, the shape of the illuminated sculpture may be more fluid or detailed. For example, in FIG. 1, the scarf of the snowman is fluid as it is a garland of optical elements 40 draped over the frame. Flat panels do not allow for the same sculptural variability as individual optical elements 40 can provide.

Further, unlike any of the prior art sculptures, the reflective and/or refractive qualities of the optical elements 40 allow the illuminated structure 10 to display the visual effects during the day because the optical elements 40 will reflect and/or refract sunlight and other light sources outside of the frame 20.

The embodiments above are intended to be illustrative and not limiting. Additional embodiments are contemplated and within the claims. Although the present invention has been described with reference to particular embodiments, those skilled in the art will recognize that changes may be made in form and detail without departing from the spirit and scope of the invention.

What is claimed is:

1. An illuminated structure comprising:
a frame configured to have at least a partially three dimensional form;
illuminating light; and
a plurality of individual optical elements disposed on at least a portion of the frame such that the plurality of individual optical elements reflect and/or refract the light.

2. The illuminated light structure of claim 1 wherein the optical elements are comprised of a thermoplastic.

3. The illuminated light structure of claim 1 wherein the optical elements are weather resistant.

4. The illuminated light structure of claim 1 wherein the optical elements are selected from a group consisting of: discs, sequins, beads, prisms, mirrors or any combination thereof.

5. The illuminated light structure of claim 1 wherein the optical elements cause a holographic effect.

6. An illuminated structure comprising:
a frame configured to have at least a partially three dimensional form;
light for illuminating the structure; and
a means for reflecting and/or refracting the light disposed on at least a portion of the frame.

7. A method for illuminating a structure comprising the steps of:
providing a frame having at least a partially three dimensional form;
illuminating the structure;
disposing a plurality of individual optical elements on at least a portion of the frame such that the individual optical elements reflect and/or refract the light.

8. An illuminated structure comprising:
a frame configured to have a form;
illuminating light associated with the frame; and
a plurality of individual optical elements disposed on at least a portion of the frame such that the plurality of individual optical elements reflect and/or refract the light.
